(19) United States
(12) Patent Application Publication
(10) Pub. No.: US 2026/0210370 A1
(43) Pub. Date: Jul. 23, 2026

(54) FAN DRIVING DEVICE AND METHOD THEREOF

(71) Applicant: NUVOTON TECHNOLOGY CORPORATION, HSINCHU CITY (TW)

(72) Inventor: Pao-Chen KO, Zhubei City (TW)

(21) Appl. No.: 19/433,555

(22) Filed: Dec. 26, 2025

(30) Foreign Application Priority Data
Jan. 23, 2025 (TW) 114102997

(51) Int. Cl. F04D 27/00; F04D 29/66; G05B 13/02

(52) U.S. Cl. CPC F04D 27/004; F04D 29/661; G05B 13/0265

(57) ABSTRACT

A fan driving device and method thereof for cooling a data processing system are provided. The fan driving device comprises a fan driving module and a machine learning module. The fan driving module outputs a driving voltage to rotate the fan. The machine learning module predicts a temperature of the data processing system after a preset time based on the number of instructions or instruction type of instructions executed or to be executed by the data processing system, and determines the driving voltage based on the temperature. The machine learning module is trained using the number of instructions, instruction type, a driving voltage and fan speed relationship table, and a fan speed and temperature relationship table.

### CROSS-REFERENCE TO RELATED APPLICATION

This application claims the priority benefit of TW114102997, filed Jan. 23, 2025, the full disclosure of which is incorporated herein by reference.

### BACKGROUND

### Technical Field

This disclosure relates to a fan driving technology, and more particularly, to a fan driving device and method thereof that uses machine learning to optimize noise and energy consumption of fan driving.

### Description of Related Art

The fan, as a common cooling device, is widely used in household equipment or office equipment. With the rising cost of energy and increasing demand for comfort, reducing unnecessary energy consumption and operating noise have become important considerations in the design of fan control systems. However, conventional fan driving methods usually adopt a way of first detecting temperature, and then determining the fan speed according to the detected temperature to perform cooling.

The aforementioned conventional fan driving methods require the data processing system to have already experienced a significant temperature increase before triggering the fan to increase its fan speed to more effectively reduce the system temperature. However, this may cause the fan to generate noise due to an excessively high instantaneous change in fan speed, and high fan speed requires a high driving voltage, thus the fan consumes more energy.

### SUMMARY

In view of the aforementioned problems, an aspect of this disclosure is to provide a fan driving device and method thereof to avoid noise caused by an excessively high instantaneous change in fan speed, and to avoid unnecessary energy consumption by the fan.

To achieve the above aspect, this disclosure reveals a fan driving device for driving a fan to rotate to dissipate heat from a data processing system. The fan driving device comprises a fan driving module and a machine learning module. The fan driving module is used to output a driving voltage to drive the fan to rotate. The machine learning module is used to predict a temperature of the data processing system after a preset time based on a number of instructions or an instruction type of instructions executed or to be executed by the data processing system, and determines the driving voltage based on the temperature. The machine learning module is trained using the number of instructions, the instruction type, a driving voltage and fan speed relationship table, and a fan speed and temperature relationship table.

In one embodiment, the number of instructions may comprise a quantity of instructions transmitted by a bus interface comprised in the data processing system per unit time, and a quantity of instructions transmitted by a memory interface comprised in the data processing system per unit time.

In one embodiment, the instruction type may comprise a mass transmission type, a continuous transmission type, or an encryption/decryption operation type.

In one embodiment, the machine learning module is trained to minimize a variation range of a fan speed of the fan.

In one embodiment, the fan driving device further comprises an update module used to receive a fan speed from the fan, and to update the driving voltage and fan speed relationship table based on the driving voltage and the received fan speed. The updated driving voltage and fan speed relationship table is used by the machine learning module for training to determine a range of the driving voltage.

In one embodiment, the machine learning module is trained based on the updated driving voltage and fan speed relationship table to minimize energy consumption of the fan driving device.

To achieve the above aspect, this disclosure further discloses a fan driving device comprising a fan driving module, a memory, and a processing module. The fan driving module outputs a driving voltage to rotate the fan. The memory stores executable instructions. The processing module executes the executable instructions to detect an instruction type or a number of instructions of instructions executed or to be executed by the data processing system. Based on the number of instructions or the instruction type, and based on a machine learning model, the processing module predicts a temperature of the data processing system after a preset time and determines the driving voltage based on the temperature. The machine learning model is trained using the number of instructions, the instruction type, a driving voltage and fan speed relationship table, and a fan speed and temperature relationship table.

In one embodiment, the number of instructions may comprise a quantity of instructions transmitted by a bus interface comprised in the data processing system per unit time, and a quantity of instructions transmitted by a memory interface comprised in the data processing system per unit time. The instruction type comprises a mass transmission type, a continuous transmission type, or an encryption/decryption operation type.

In one embodiment, the machine learning model is trained using the number of instructions, the instruction type, the driving voltage and fan speed relationship table, and the fan speed and temperature relationship table to minimize a variation range of a fan speed of the fan.

To achieve the above aspect, this disclosure reveals a fan driving method comprising the following steps. An instruction type or a number of instructions are detected. A machine learning module is used to predict a temperature after a preset time and determining a driving voltage based on the temperature. The machine learning module is trained using the number of instructions, the instruction type, a driving voltage and fan speed relationship table, and a fan speed and temperature relationship table. The driving voltage is output to drive the fan to rotate.

According to the above technical solutions, this disclosure can predict the temperature of the data processing system after a preset time and determine the driving voltage based on the temperature. While using the fan for cooling, the fan speed can be controlled to avoid a high variation range, thereby reducing fan noise. Meanwhile, this disclosure can update the driving voltage and fan speed relationship table in real time, and use the updated driving voltage and fan speed relationship table for training to minimize the energy consumption of the fan driving device, avoiding unnecessary energy consumption.

### BRIEF DESCRIPTION OF THE DRAWINGS

FIG. 1 is a block diagram of a fan driving device according to an embodiment of this disclosure.

FIG. 2 is a comparison diagram of fan speed using a conventional fan driving method versus fan speed using this disclosure.

FIG. 3 is a graph illustrating curves showing a relationship between driving voltage and fan speed before and after an update according to this disclosure.

FIG. 4 is a schematic diagram of training a machine learning module according to this disclosure.

FIG. 5 is a schematic diagram of a fan driving device and a data processing system according to another embodiment of this disclosure.

FIG. 6 is a flowchart of a fan driving method according to this disclosure.

### DETAILED DESCRIPTION

The following description, in conjunction with the accompanying drawings and embodiments, provides a detailed explanation of the implementation of this disclosure. This allows for a thorough understanding and implementation of the process by which this disclosure applies technical means to solve technical problems and achieve technical effects.

To make the features and advantages of this disclosure more apparent and easy to understand, specific embodiments of this disclosure are described in detail below in conjunction with the accompanying drawings. The following description contains specific information related to exemplary embodiments in this disclosure. The drawings and their accompanying detailed description in this disclosure are merely exemplary embodiments. However, this disclosure is not limited to these exemplary embodiments. Other variations and embodiments of this disclosure will occur to those skilled in the art. Unless otherwise stated, the same or corresponding elements in the drawings may be indicated by the same or corresponding reference numerals. In addition, the drawings and illustrations in this disclosure are generally not drawn to scale and are not intended to correspond to actual relative dimensions.

In addition, spatially relative terms such as “beneath,” “below,” “lower,” “above,” “over,” “upper,” and similar terms may be used herein. These spatially relative terms are used for the convenience of describing the relationship between one element or feature and another element or feature as illustrated in the drawings. These spatially relative terms encompass different orientations of the device in use or operation in addition to the orientation depicted in the drawings. When the device is turned to different orientations (rotated 90 degrees or at other orientations), the spatially relative descriptors used therein shall also be interpreted according to the orientation after turning.

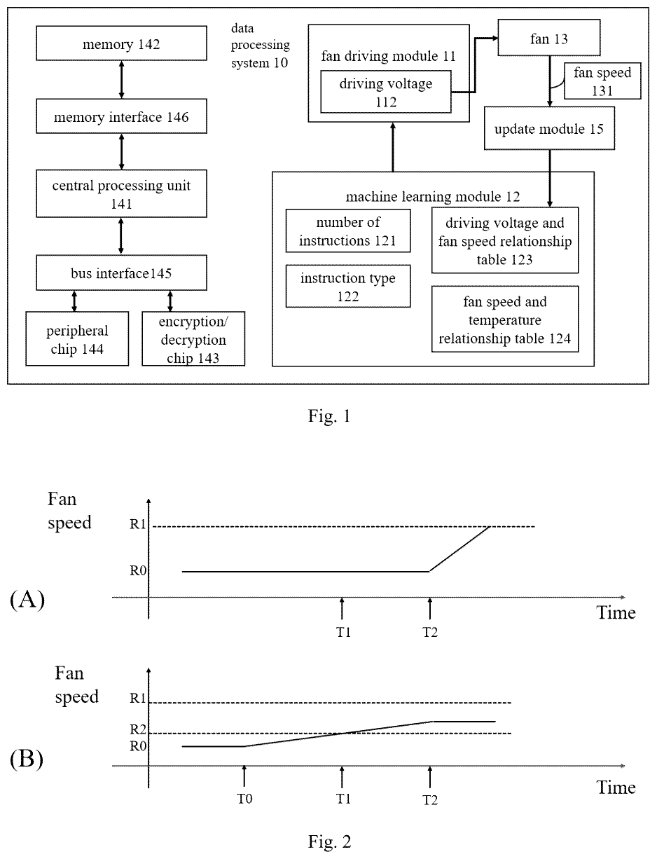

Please refer to FIG. 1, which is a block diagram of a fan driving device according to an embodiment of this disclosure. As shown in FIG. 1, the fan driving device of this disclosure is used to drive a fan 13 to rotate to dissipate heat from a data processing system 10. The data processing system 10 at least comprises a central processing unit 141, a memory 142, a peripheral chip 144, an encryption/decryption chip 143, a bus interface 145, and a memory interface 146.

The fan driving device comprises a fan driving module 11 and a machine learning module 12. If necessary, the fan driving device may further comprise an update module 15. Although the fan driving device and the fan 13 are included in the data processing system 10 in FIG. 1, this disclosure is not limited thereto. For example, the fan driving device or the fan 13 may be disposed outside the data processing system 10. The rotation of the fan 13 drives gas flow within the data processing system 10, thereby dissipating thermal energy generated by heat sources of the data processing system 10.

The fan driving module 11 is used to output a driving voltage 112 to drive the fan 13 to rotate. The machine learning module 12 is used to predict a temperature of the data processing system 10 after a preset time based on a number of instructions 121 or an instruction type 122 of instructions executed or to be executed by the data processing system 10, and determines the driving voltage 112 based on the temperature. The machine learning module 12 is trained using the number of instructions 121 of the instructions executed by the data processing system 10, the instruction type 122, a driving voltage and fan speed relationship table 123, and a fan speed and temperature relationship table 124. In one embodiment, the machine learning module 12 is trained to minimize a variation range of a fan speed 131 of the fan 13 or to maintain the variation range within a preset range, thereby reducing noise generated by the fan 13. It should be noted that the instructions used for predicting the temperature may be instructions currently being executed by the data processing system 10, or instructions detected from relevant interfaces that are about to be executed by the data processing system 10. It should be noted that either the number of instructions 121 or the instruction type 122 may be selected for predicting the temperature, or both may be used for predicting the temperature.

Since increasing the fan speed only after detecting a temperature rise tends to cause the fan speed to change with a high variation range, which is the primary cause of fan noise, the machine learning module 12 predicts the temperature of the data processing system 10 after a preset time and determines the driving voltage 112 based on the temperature. This allows for the control of the fan speed to avoid a high variation range while using the fan for cooling, thereby reducing fan noise.

In one embodiment, the number of instructions 121 may comprise a quantity of instructions transmitted by a bus interface 145 comprised in the data processing system 10 per unit time, and a quantity of instructions transmitted by a memory interface 146 comprised in the data processing system 10 per unit time. For example, the number of instructions 121 may be a quantity of instructions transmitted per unit time by the bus interface 145 between a plurality of chips (such as the central processing unit 141, the peripheral chip 144, and the encryption/decryption chip 143) comprised in the data processing system 10, or a quantity of instructions transmitted per unit time by the memory interface 146 used by the memory 142 comprised in the data processing system 10. The aforementioned instructions comprise instructions executable by the central processing unit 141, instructions executable by the peripheral chip 144, or instructions executable by the encryption/decryption chip 143. The aforementioned memory 142 may comprise any type of volatile memory and/or non-volatile memory (NVRAM), such as static random access memory (SRAM), dynamic random access memory (DRAM), read-only memory (ROM), flash memory, cache memory, and the like.

In one embodiment, the instruction type 122 may comprise a mass transmission type, a continuous transmission type, or an encryption/decryption operation type. For example, instructions matching the instruction type 122 comprise mass transmission types (such as DMA instructions, BULK READ instructions, and AMBA burst transmission instructions), continuous transmission types (such as AMBA burst transmission instructions), and encryption/decryption operation type instructions. These instructions all require a chip to perform a large number of logical operations or mathematical operations, and such operations cause the chip to generate a large amount of thermal energy.

which is a comparison diagram of fan speed using a conventional fan driving method versus fan speed implemented according to this disclosure. Part (A) of FIG. 2 shows the fan speed using the conventional fan driving method, and part (B) of FIG. 2 illustrates the fan speed achieved by the fan driving device of this disclosure. As shown in part (A) of FIG. 2, the fan speed is R0 at time T1. When the central processing unit executes mass transmission type instructions at time T1, a temperature sensor senses a temperature rise in the data processing system 10 at time T2. According to a preset method (such as a preset look-up table method or a preset algorithm), it is determined that the fan speed must reach R1 as soon as possible. This causes the fan speed to have a high variation range during the period when the fan speed is increasing (for example, after time T2), resulting in significant noise.

As shown in part (B) of FIG. 2, the fan speed is R0 at time T0. The machine learning module 12 of the fan driving device of this disclosure can learn through the bus interface 145 at time T0 that the central processing unit 141 is about to execute mass transmission type instructions. Since the machine learning module 12 is trained, it can predict the temperature of the data processing system 10 after a preset time and can determine the driving voltage 112 based on this temperature, such that the fan 13 begins increasing the fan speed at time T0. At this time, the central processing unit 141 has not yet executed the mass transmission type instructions and has not yet generated additional thermal energy. Preemptively increasing the fan speed allows the data processing system 10 to cool down in advance. By the time the central processing unit 141 executes the mass transmission type instructions at time T1 and generates additional thermal energy, because the data processing system 10 has already been cooled in advance, the temperature of the data processing system 10 will not rise excessively due to the execution of mass transmission type instructions. Therefore, the fan speed does not need to increase to R1 to maintain the data processing system 10 at an appropriate temperature. Since the fan 13 preemptively increases the fan speed at time T0, there is a lower variation range during the period when the fan speed is increasing (for example, from time T0 to T2), resulting in lower noise.

In practical operation, after the fan has been used for a period of time, dust tends to adhere to the blades of the fan, and this phenomenon seriously affects the rotational capability of the fan. In other words, to achieve the same fan speed, a fan with dust adhesion requires a higher driving voltage than a fan without dust adhesion. If the fan driving method is not adjusted accordingly, unnecessary energy consumption will occur. To reduce the influence of dust on the fan, the fan driving device may further comprise an update module 15. The update module 15 is used to receive a fan speed 131 from the fan 13, and update the driving voltage and fan speed relationship table 123 based on the driving voltage 112 and the received fan speed 131. The machine learning module 12 is trained based on the updated driving voltage and fan speed relationship table 123 to determine a range of the driving voltage 112.

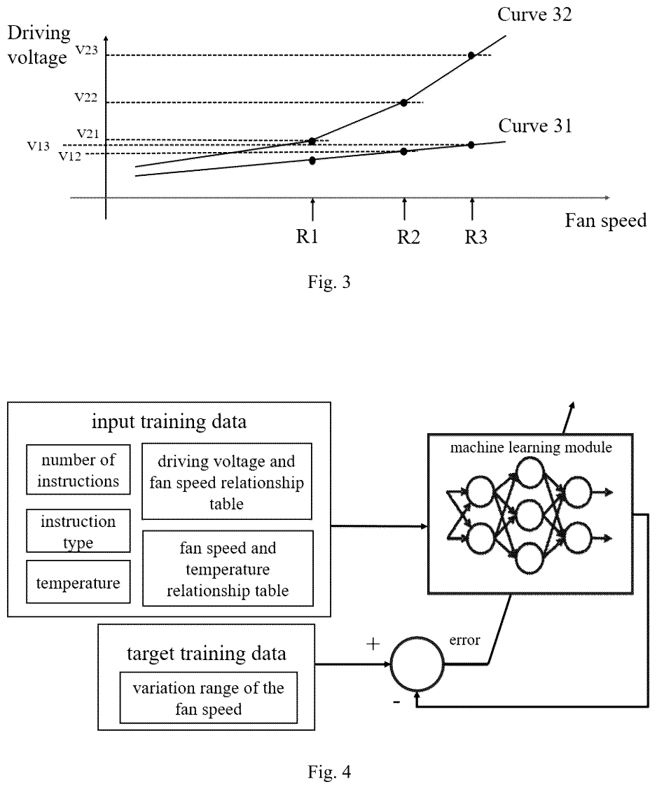

Please refer to FIG. 3, which is a graph illustrating curves showing a relationship between driving voltage and fan speed before and after an update according to this disclosure. As shown in FIG. 3, curve 31 represents data of the initial driving voltage and fan speed relationship table 123 of the fan 13, which is the relationship between the driving voltage and the fan speed of a fan without dust adhesion. Curve 32 represents the updated driving voltage and fan speed relationship table 123, which is the relationship between the driving voltage and the fan speed of a fan with dust adhesion. It can be seen that the influence of dust is greater at a higher fan speed, and the increase in driving voltage is larger. For example, according to curve 31 and curve 32, the increase in driving voltage (V13 to V23) required for fan speed R3 is larger than the increase in driving voltage (V12 to V22) required for fan speed R2.

To reduce the influence of dust on the fan speed 131, the machine learning module 12 may be trained based on the updated driving voltage and fan speed relationship table 123 to determine a range of the driving voltage 112, thereby minimizing energy consumption of the fan driving device or maintaining it within a preset energy consumption range. For example, in conjunction with the predicted temperature, the machine learning module 12 may determine not to use a fan speed 131 exceeding R2. That is, the range of the driving voltage 112 corresponding to a maximum fan speed 131 of R2 is used to maintain the temperature of the data processing system 10, thereby avoiding unnecessary energy consumption by the fan 13 and minimizing the energy consumption of the fan 13 or maintaining it within a preset energy consumption range.

In some embodiments, the machine learning module 12 may use one or more well-known artificial intelligence (AI) learning algorithms or machine learning algorithms to perform training of a machine learning model. The aforementioned algorithms may comprise neural networks (for example, artificial neural networks, deep neural networks, convolutional neural networks (CNN), recurrent neural networks (RNN), autoencoders, reinforcement learning, etc.), fuzzy logic, artificial intelligence (AI), deep learning algorithms, deep structured learning hierarchical learning algorithms, support vector machines (SVM) (for example, linear SVM, non-linear SVM, SVM regression), decision tree learning (for example, classification and regression trees (CART)), dimensionality reduction algorithms (for example, projection, manifold learning, principal component analysis, etc.), and/or deep machine learning algorithms.

The implementation of the machine learning module 12 may at least comprise two stages: a training phase (also referred to as a learning phase) and an inference phase (also referred to as a generation phase). During the training phase, the machine learning module 12 basically learns by comparing its actual output with a correct output (or at least an output closer to a desired output) to discover errors. Then, the machine learning module 12 modifies the model accordingly. During the inference phase, the trained machine learning module 12 is configured in the fan driving device and is capable of providing an output corresponding to any input.

It should be noted that the machine learning module 12 can be implemented in various ways, including software, hardware, or any combination thereof. For example, in some embodiments, the machine learning module 12 can be implemented using software and hardware or either of them. For instance, the machine learning module 12 is implemented by using a processor with sufficient computing power to execute program instructions to run the algorithm of a machine learning model. In addition, this disclosure can also be implemented partially or completely based on hardware. For example, the machine learning module 12 can be implemented through an integrated circuit chip, a system on chip (SoC), a complex programmable logic device (CPLD), a field programmable gate array (FPGA), and the like. The program instructions for performing the operations of this disclosure may be assembly language instructions, instruction set architecture instructions, machine instructions, machine-related instructions, micro-instructions, firmware instructions, or source code or object code written in any combination of one or more programming languages. The aforementioned programming languages include object-oriented programming languages, such as Common Lisp, Python, C++, Objective-C, Smalltalk, Delphi, Java, Swift, C #, Perl, Ruby, PHP, and the like, as well as conventional procedural programming languages, such as C language or similar programming languages.

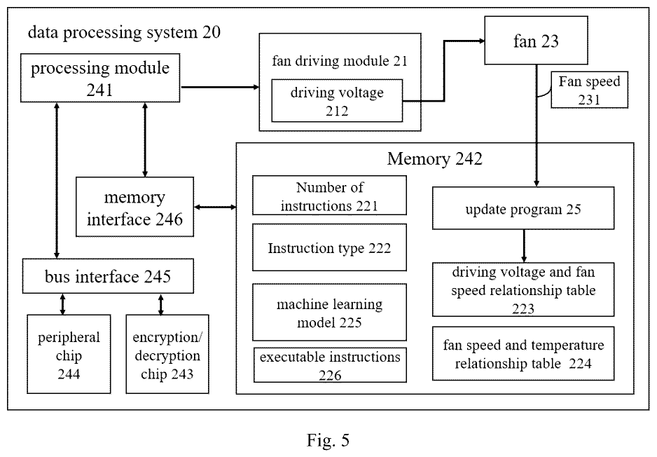

Please refer to FIG. 4, which is a schematic diagram of a training phase of the machine learning module 12 of this disclosure. The training data set used by the machine learning module 12 of this disclosure comprises input training data and target training data. The input training data may comprise temperature, a number of instructions, an instruction type, temperature, a driving voltage and fan speed relationship table, and a fan speed and temperature relationship table. The target training data comprises a variation range of the fan speed. For example, a user collects data on how much the temperature of the data processing system 10 rises after a preset time caused by a specific instruction type, and then performs a table lookup from the driving voltage and fan speed relationship table and the fan speed and temperature relationship table to obtain a driving voltage that can be used while satisfying a target value for the variation range of the fan speed. The aforementioned training data set is input into the machine learning module 12 for machine learning model training.

Please refer to FIG. 5, which is a block diagram of a fan driving device according to another embodiment of this disclosure. As shown in FIG. 5, the fan driving device is used to drive a fan 23 to rotate to dissipate heat from a data processing system 20. The fan driving device comprises a fan driving module 21, a memory 242, and a processing module 241. The fan driving module 21 is used to output a driving voltage 212 to drive the fan 23 to rotate. The memory 242 stores executable instructions 226, a driving voltage and fan speed relationship table 223, a fan speed and temperature relationship table 224, and a machine learning model 225. The processing module 241 executes the executable instructions 226 to perform the following operations.
Operation 1: Detect an instruction type or a number of instructions 221 of instructions executed or to be executed by the data processing system 20. The executable instructions 226 or the aforementioned detected instructions may be a type of program instruction, which has been described in the previous paragraph and thus will not be repeated herein.
Operation 2: Based on a machine learning model 225, and based on the number of instructions 221 or the instruction type 222, predict a temperature of the data processing system 20 after a preset time, and determine the driving voltage 212 based on the temperature.

In one embodiment, after the machine learning model 225 is trained, the processing module 241 executes the executable instructions 226 to run the trained machine learning model 225 for inference, thereby generating the driving voltage 212. This allows a variation range of a fan speed 231 of the fan 23 to be minimized or maintained within a preset range during a period when the fan speed is increasing, thereby reducing noise generated by the fan 23. The training method of the machine learning model 225 has been described in previous paragraphs in conjunction with FIG. 4 and thus will not be repeated herein.

In one embodiment, the number of instructions 221 may comprise a quantity of instructions transmitted per unit time by a bus interface 245 comprised in the data processing system 20, and a quantity of instructions transmitted per unit time by a memory interface 246 comprised in the data processing system 20. In one embodiment, the instruction type 222 may comprise a mass transmission type, a continuous transmission type, or an encryption/decryption operation type.

To reduce the influence of dust on the fan, the fan driving device may further execute an update program 25 stored in the memory 242 to receive a fan speed 231 from the fan 23, and update the driving voltage and fan speed relationship table 223 based on the driving voltage 212 and the received fan speed 231. The machine learning model 225 is trained based on the updated driving voltage and fan speed relationship table 223 to determine a range of the driving voltage 112, thereby minimizing energy consumption of the fan driving device or maintaining it within a preset energy consumption range.

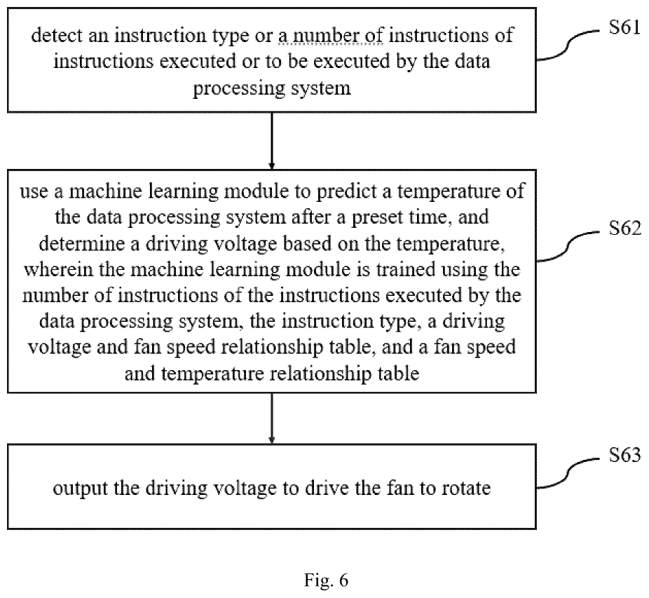

Please refer to FIG. 6, which is a flowchart of a fan driving method according to this disclosure. As shown in FIG. 6, a fan driving method is used to drive a fan to rotate to dissipate heat from a data processing system, and the method comprises the following steps.

In step S61, an instruction type or a number of instructions of instructions executed or to be executed by the data processing system is detected. In step S62, a temperature of the data processing system after a preset time is predicted by using a machine learning module, and a driving voltage is determined based on the temperature, wherein the machine learning module is trained using the number of instructions of the instructions executed by the data processing system, the instruction type, a driving voltage and fan speed relationship table, and a fan speed and temperature relationship table. In step S63, the driving voltage is outputted to drive the fan to rotate.

In one embodiment, the fan driving method may further comprise receiving a fan speed from the fan 23, and updating the driving voltage and fan speed relationship table based on the driving voltage and the received fan speed. The machine learning model is trained based on the updated driving voltage and fan speed relationship table to determine a range of the driving voltage, thereby minimizing energy consumption of the fan driving device or maintaining it within a preset energy consumption range.

Although this disclosure has been disclosed as above through the aforementioned embodiments, they are not intended to limit this invention. Any person skilled in the similar art may make some modifications and refinements without departing from the spirit and scope of this disclosure. Therefore, the scope of patent protection of this disclosure shall be defined by the appended claims of this specification.

What is claimed is:

1. A fan driving device for driving a fan to rotate to dissipate heat from a data processing system, the fan driving device comprising:
a fan driving module configured to output a driving voltage to drive the fan to rotate; and
a machine learning module configured to:
predict a temperature of the data processing system after a preset time based on a number of instructions or an instruction type of instructions executed or to be executed by the data processing system; and
determine the driving voltage based on the temperature, the machine learning module being trained using the number of instructions of the instructions executed by the data processing system, the instruction type, a driving voltage and fan speed relationship table, and a fan speed and temperature relationship table.

2. The fan driving device of claim 1, wherein the number of instructions comprises:
the number of instructions transmitted by a bus interface comprised in the data processing system within a per unit time; and
the number of instructions transmitted by a memory interface comprised in the data processing system within the per unit time.

3. The fan driving device of claim 1, wherein the instruction type comprises a mass transmission type, a continuous transmission type, or an encryption/decryption operation type.

4. The fan driving device of claim 1, wherein the machine learning module is trained to minimize a variation range of a fan speed of the fan.

5. The fan driving device of claim 1, further comprising an update module, configured to:
receive a fan speed from the fan; and
update the driving voltage and fan speed relationship table based on the driving voltage and the received fan speed, wherein the updated driving voltage and fan speed relationship table is used by the machine learning module to determine a range of the driving voltage.

6. The fan driving device of claim 5, wherein the machine learning module is trained based on the updated driving voltage and fan speed relationship table to minimize energy consumption of the fan driving device.

7. A fan driving device for driving a fan to rotate to dissipate heat from a data processing system, the fan driving device comprising:
a fan driving module configured to output a driving voltage to drive the fan to rotate;
a memory configured to store executable instructions; and
a processing module configured to execute the executable instructions to perform the following:
detecting an instruction type or a number of instructions of instructions executed or to be executed by the data processing system; and
predicting a temperature of the data processing system after a preset time based on the number of instructions or the instruction type and based on the machine learning model, and determining the driving voltage based on the temperature, wherein the machine learning model is trained using the number of instructions of the instructions executed by the data processing system, the instruction type, a driving voltage and fan speed relationship table, and a fan speed and temperature relationship table.

8. The fan driving device of claim 7, wherein the number of instructions comprises:
the number of instructions transmitted by a bus interface comprised in the data processing system within a per unit time; and
the number of instructions transmitted by a memory interface comprised in the data processing system within the per unit time; and
the instruction type comprises a mass transmission type, a continuous transmission type, or an encryption/decryption operation type.

9. The fan driving device of claim 7, wherein the machine learning model is trained using the number of instructions, the instruction type, the driving voltage and fan speed relationship table, and the fan speed and temperature relationship table to minimize a variation range of a fan speed of the fan.

10. A fan driving method for driving a fan to rotate to dissipate heat from a data processing system, the fan driving method comprising:
detecting an instruction type or a number of instructions of instructions executed or to be executed by the data processing system;
using a machine learning module to predict a temperature of the data processing system after a preset time, and determining a driving voltage based on the temperature, wherein the machine learning module is trained using the number of instructions of the instructions executed by the data processing system, the instruction type, a driving voltage and fan speed relationship table, and a fan speed and temperature relationship table; and
outputting the driving voltage to drive the fan to rotate.
